(19) United States
(12) Patent Application Publication
(10) Pub. No.: US 2024/0243593 A1
(43) Pub. Date: Jul. 18, 2024

(54) Wireless Mouse Charging Dock

(71) Applicant: Douglas Black, JR., McKees Rocks, PA (US)

(72) Inventor: Douglas Black, JR., McKees Rocks, PA (US)

(21) Appl. No.: 18/096,113

(22) Filed: Jan. 12, 2023

(51) Int. Cl. H02J 7/00

(52) U.S. Cl. CPC H02J 7/0044; H02J 2207/30

(57) ABSTRACT

The present disclosure provides a wireless mouse charging dock with a housing which is shaped to receive and charge a wireless mouse with a vertically oriented charging port on its bottom surface while facilitating continued use of the docked mouse. This is achieved by a housing having a compact, curved profile with a flat bottom surface that allows the charging dock to glide over a substrate similarly to a wireless mouse itself, and by having a receiving area that cradles the mouse and which has an opening formed therein that provides an unobscured view of said substrate to the mouse sensor.

### FIELD OF INVENTION

The present invention relates generally to the field of computer accessories. More specifically the present invention relates to a charging dock that allows seamless continued use of a wireless mouse during the charging process.

### BACKGROUND

The use of wireless computer mice with rechargeable batteries has increased enormously in recent years and they are now used ubiquitously due to the convenience and portability they provide over traditional wired mice.

One particularly popular mouse model is the Apple Magic Mouse™, the design is popular due to its sleek low-to-the-ground profile and its compatibility with other Apple products. There is an issue with the product however, which is that the charging port is located along the bottom surface of the mouse and is oriented vertically, meaning that it is impossible to use the product while it is being recharged. This means that users who may be relying on its use are left without it for inconvenient periods of time.

Wireless mouse charging docks exist, but there are none currently available which allow for seamless continued use of a wireless mouse having a vertically oriented charging port along its bottom during the charging process.

It is within this context that the present invention is provided.

### SUMMARY

The present disclosure provides a wireless mouse charging dock with a housing which is shaped to receive and charge a wireless mouse with a vertically oriented charging port on its bottom surface while facilitating continued use of the docked mouse. This is achieved by a housing having a compact, curved profile with a flat bottom surface that allows the charging dock to glide over a substrate similarly to a wireless mouse itself, and by having a receiving area that cradles the mouse and which has an opening formed therein that provides an unobscured view of said substrate to the mouse sensor.

Thus, according to a first aspect of the present disclosure, there is provided a wireless mouse charging dock, comprising: a charger cable having a lightning connector at a first end and a second end configured to couple to a power source; and a housing, the housing having an ovaloid profile with a flat bottom surface and a curved top surface with an indented receiving area for securing a wireless mouse, the indented receiving area having formed therein a pair of parallel grooves for interfacing with the mouse bottom, a first opening that runs through to the bottom surface and is positioned to align with a sensor of a docked mouse, and a second opening positioned to align with a charging port of a docked mouse, the housing further comprising a third opening positioned at a first end of the receiving area adjacent to the first opening, the third opening forming an internal pathway to the second opening.

The charger cable is threaded through the internal pathway of the housing and affixed securely with the lightning connector protruding from the second opening.

In some embodiments, the charging connector is a lightning charging connector.

In some embodiments, the second end of the charger cable comprises a USB or USB-C connector.

In some embodiments, the curved top surface of the housing is profiled such that a docked mouse forms an unbroken curve with the receiving area edges.

In some embodiments, the bottom surface is configured with a low friction coefficient.

In some embodiments, the height of the bottom of the receiving area is less than 1 cm above the flat bottom surface of the housing.

In some embodiments, the housing is hollow and is formed of a bottom piece and a top piece affixed together by removable screws.

In some embodiments, the housing is formed of a plastic material.

In some embodiments, the first opening has an unbroken side wall to prevent the length of the charger cable from obscuring the line of sight between a docked mouse and a substrate on which the dock rests.

### BRIEF DESCRIPTION OF THE DRAWINGS

Various embodiments of the invention are disclosed in the following detailed description and accompanying drawings.

FIG. 1 illustrates an isometric perspective view of the top of an example configuration of the disclosed wireless mouse charging dock.

FIG. 2 illustrates an isometric perspective view of the bottom of the example wireless mouse charging dock.

FIG. 3 illustrates an isometric perspective view of the top of the example configuration with a wireless mouse installed in the receiving area.

FIG. 4 illustrates a first isometric view of the top and bottom portions of the housing of the example configuration.

FIG. 5 illustrates a second isometric view of the top and bottom portions of the housing of the example configuration.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The terms “about” and “approximately” shall generally mean an acceptable degree of error or variation for the quantity measured given the nature or precision of the measurements. Typical, exemplary degrees of error or variation are within 20 percent (%), preferably within 10%, and more preferably within 5% of a given value or range of values. Numerical quantities given in this description are approximate unless stated otherwise, meaning that the term “about” or “approximately” can be inferred when not expressly stated.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments.

The terminology used herein is for the purpose of describing particular embodiments only and is not intended to be limiting. As used herein, the singular forms “a,” “an” and “the” are intended to include the plural forms as well, unless the context clearly indicates otherwise.

Spatially relative terms, such as “under,” “below,” “lower,” “over,” “upper” and the like, may be used herein for ease of description to describe one element or feature's relationship to another when the apparatus is right side up.

The terms “first,” “second,” and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

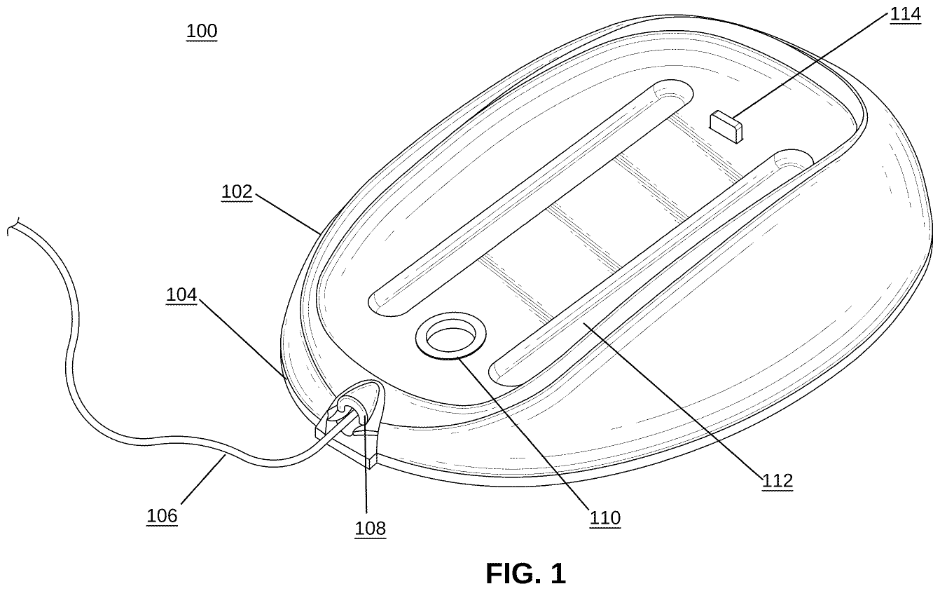

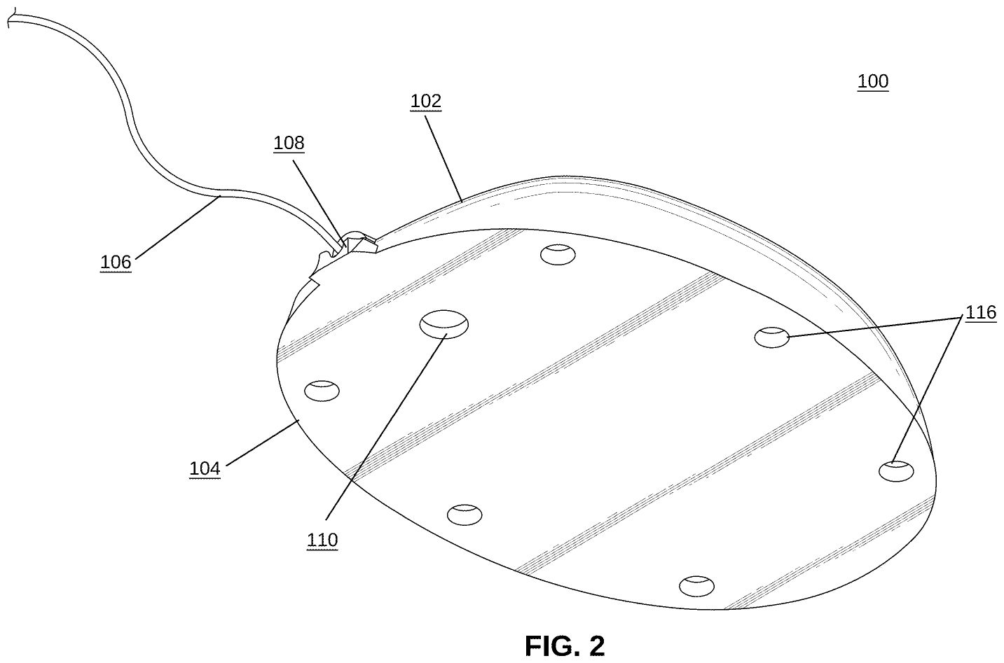

Referring to FIG. 1 and FIG. 2, isometric perspective views are shown of the top and bottom of an example wireless mouse charging dock 100 according to the present disclosure.

As can be seen, the charging dock 100 comprises a housing formed of a top portion 102 and a bottom portion 104, that together created a rounded or ovaloid profile with a flat bottom surface and a curved top surface with a receiving area for a wireless mouse such as the Apple Magic Mouse™ formed therein.

The two housing portions together form a hollow space, with an opening 108 through which a charging cable 106 is threaded. The charging cable 106 is secured inside the housing so that the tip 114 protrudes vertically from an opening in the receiving area. In the present example tip 114 is a lightning connector of a USB charging cable. The receiving area also has an opening 110 that runs through both portions of the housing so that a substrate under the charging dock 100 will be visible to a sensor of a docked wireless mouse, allowing it to continue to operate while being charged via tip 114.

The receiving area also has a set of two parallel grooves 112 formed therein that will interface with the treads of a docked wireless mouse for a more secure fit.

The flat bottom of the dock 100, which is secured to the top via screw arrangements 116 in the present example, allows the dock to easily glide over substrates in a similar manner to a mouse itself.

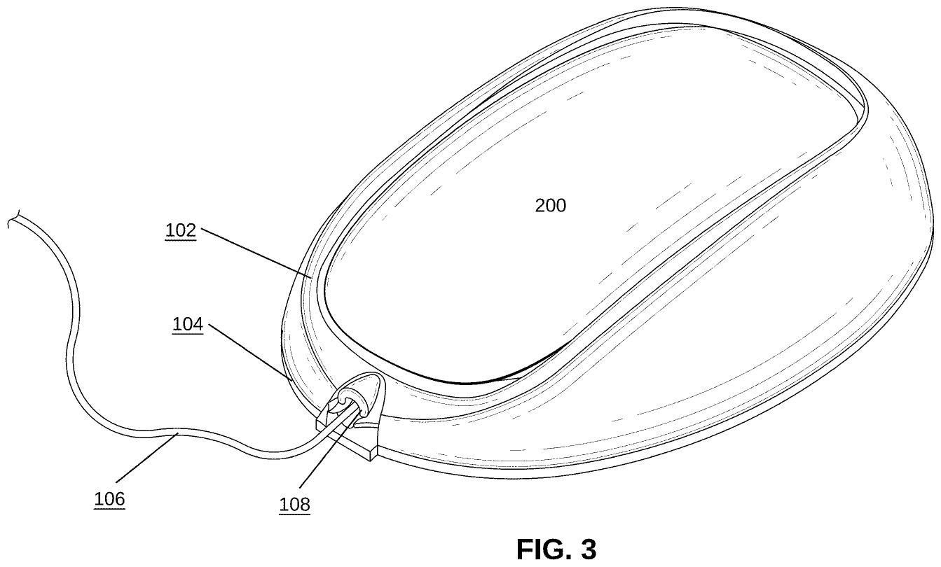

Furthermore, the curved top profile of the dock 100 and its low-to-the-ground design mean that a docked mouse has an almost uninterrupted profile with the top of the dock 100 and fits ergonomically in the hand as can be seen from FIG. 3 which shows a charging mouse 200 installed in the dock 100.

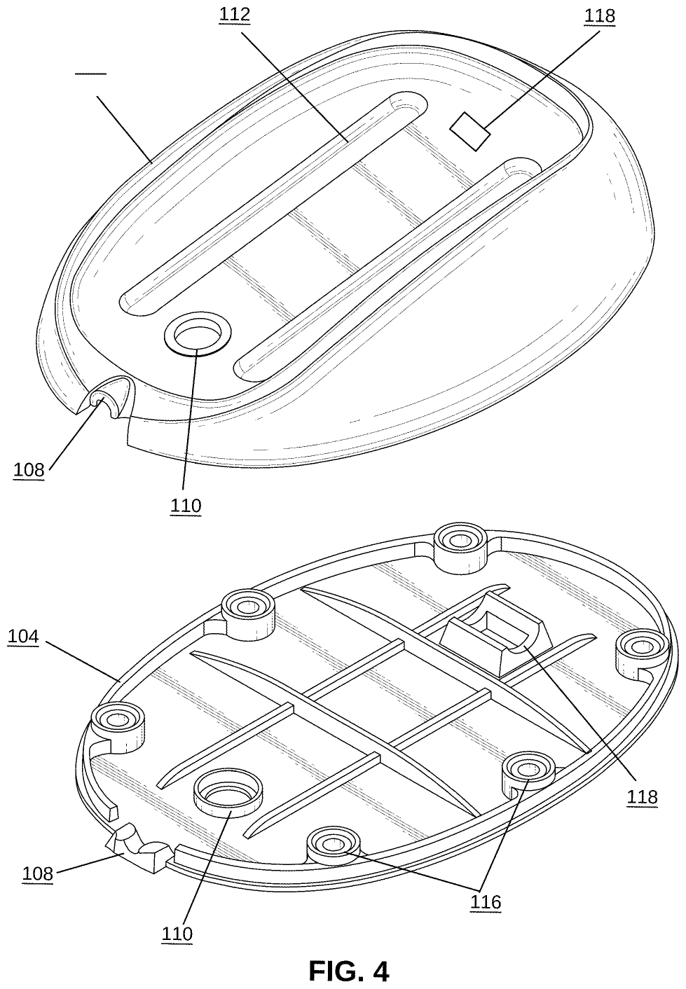

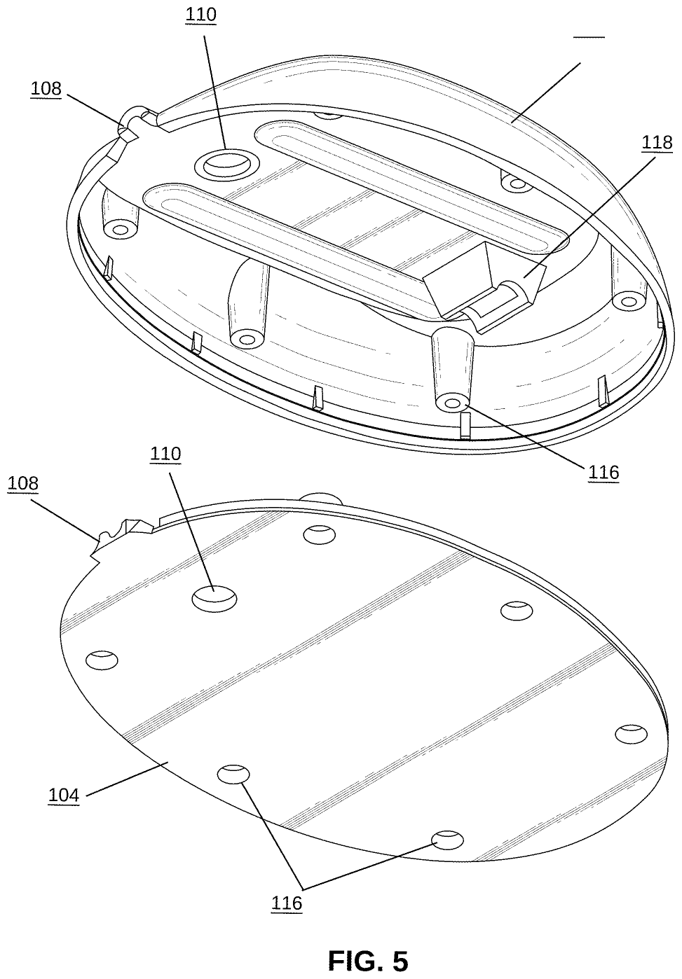

Referring to FIG. 4 and FIG. 5, isometric views are shown of the upper portion 102 and lower portion 104 of the dock's housing to show how the internal portions of the dock 100 might be constructed.

As can be seen, the internal structure of the dock comprises a ringed wall about opening 110 so that the opening for the mouse sensor remains unobscured, and a securing arrangement for opening 118 that will keep the tip 114 of the charging cable in place in the opening.

Together, the above described features enable seamless use of a wireless mouse installed in the dock while it is being charged, even with a charging port that is oriented vertically on the bottom of the mouse. This reduces inconvenience and increases reliability for users.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the wireless mouse charging dock have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A wireless mouse charging dock, comprising:
a charger cable having a charging connector at a first end and a second end configured to couple to a power source;
a housing, the housing having an ovaloid profile with a flat bottom surface and a curved top surface with an indented receiving area for securing a wireless mouse, the indented receiving area having formed therein a pair of parallel grooves for interfacing with the mouse bottom, a first opening that runs through to the bottom surface and is positioned to align with a sensor of a docked mouse, and a second opening positioned to align with a charging port of a docked mouse, the housing further comprising a third opening positioned at a first end of the receiving area adjacent to the first opening, the third opening forming an internal pathway to the second opening;
wherein the charger cable is threaded through the internal pathway of the housing and affixed securely with the lightning connector protruding from the second opening.

2. A wireless mouse charging dock according to claim 1, wherein the charging connector is a lightning charging connector.

3. A wireless mouse charging dock according to claim 1, wherein the second end of the charger cable comprises a USB or USB-C connector.

4. A wireless mouse charging dock according to claim 1, wherein the curved top surface of the housing is profiled such that a docked mouse forms an unbroken curve with the receiving area edges.

5. A wireless mouse charging dock according to claim 1, wherein the bottom surface is configured with a low friction coefficient.

6. A wireless mouse charging dock according to claim 1, wherein the height of the bottom of the receiving area is less than 1 cm above the flat bottom surface of the housing.

7. A wireless mouse charging dock according to claim 1, wherein the housing is hollow and is formed of a bottom piece and a top piece affixed together by removable screws.

8. A wireless mouse charging dock according to claim 1, wherein the housing is formed of a plastic material.

9. A wireless mouse charging dock according to claim 1, wherein the first opening has an unbroken side wall to prevent the length of the charger cable from obscuring the line of sight between a docked mouse and a substrate on which the dock rests.
